(19) United States
(12) Patent Application Publication
(10) Pub. No.: US 2025/0390053 A1
(43) Pub. Date: Dec. 25, 2025

(54) IMAGE FORMING APPARATUS

(71) Applicant: Toshiba Tec Kabushiki Kaisha, Tokyo (JP)

(72) Inventor: Ken IGUCHI, Numazu Shizuoka (JP)

(21) Appl. No.: 19/058,495

(22) Filed: Feb. 20, 2025

(30) Foreign Application Priority Data
Jun. 25, 2024 (JP) 2024-101858

(51) Int. Cl. G03G 15/00; G06K 19/077

(52) U.S. Cl. CPC G03G 15/6591; G06K 19/07773

(57) ABSTRACT

According to an embodiment, an image forming apparatus communicates with a predetermined number of wireless tags of one or more supplied media on a basis of a printing job, and forms images on a predetermined number of printing regions corresponding to the wireless tags. The image forming apparatus outputs information for checking whether or not retry processing, which is executed in accordance with a failure to write tag information to the one or more wireless tags of the one or more media, is necessary and receives a request for the retry processing.

### CROSS-REFERENCE TO RELATED APPLICATIONS

This application is based upon and claims the benefit of priority from the prior Japanese Patent Application No. 2024-101858, filed on Jun. 25, 2024, the entire contents of which are incorporated herein by reference.

### FIELD

An embodiment to be described here generally relates to an image forming apparatus.

### BACKGROUND

In recent years, wireless tags using a radio frequency identifier (RFID) technology have become widespread and various proposals have been made for image forming apparatuses capable of supporting wireless tags, which process media to which the wireless tags are attached. The image forming apparatus includes a reader/writer that wirelessly communicates with a wireless tag of a medium. Further, the image forming apparatus houses the medium with the wireless tag in a cassette, reads information from the wireless tag of the medium conveyed inside the apparatus using the reader/writer, and writes information to the wireless tag of the conveyed medium. Further, the image forming apparatus forms an image on the medium with the wireless tag and outputs the medium on which the image has been formed to an output tray.

In the case where information cannot be written to the wireless tag of the medium through communication with the wireless tag, the image forming apparatus does not form an image on the medium. In this case, the image forming apparatus executes retry processing of supplying a new medium, writing information to a wireless tag of the new medium, and forming an image on the medium.

In the case where a plurality of wireless tags is attached to one medium, executing retry processing using a new medium due to a failure to write information to one wireless tag is against the user's will in some cases.

### BRIEF DESCRIPTION OF THE DRAWINGS

FIG. 1 is a schematic diagram showing an example of an image forming apparatus according to an embodiment.

FIG. 2 is a block diagram showing an example of a hardware configuration of the image forming apparatus according to the embodiment.

FIG. 3 is a diagram showing an example of a predetermined number of wireless tags and a predetermined number of printing regions on a medium according to the embodiment.

FIG. 4 is a diagram showing an example of writing information to the predetermined number of wireless tags on the medium according to the embodiment and printing images on the printing regions according to the writing results.

FIG. 5 is a flowchart showing an example of media processing according to the embodiment.

FIG. 6 is a diagram showing an example of retry processing according to the embodiment. Note that the retry processing is also referred to as retry printing.

FIG. 7 is a diagram describing an example of the printing job and the retry processing according to the embodiment.

FIG. 8 is a diagram showing an example of outputting information for checking whether or not the retry processing according to the embodiment is necessary.

FIG. 9 is a schematic diagram showing an example of state transition according to the necessity of executing the retry processing according to the embodiment.

FIG. 10 is a diagram showing a first modification of determination criteria for determining execution timing of the retry processing according to the embodiment.

FIG. 11 is a diagram showing a second modification of determination criteria for determining execution timing of the retry processing according to the embodiment.

### DETAILED DESCRIPTION

According to an embodiment, an image forming apparatus includes: an interface, a supply device, a wireless communication device, an image forming device, an input/output device, and a processor. The interface inputs a printing job. The supply device supplies, on the basis of the printing job, one or more media to which a predetermined number, which is two or more, of wireless tags are attached. The wireless communication device communicates with the predetermined number of wireless tags of the one or more supplied media on the basis of the printing job and writes tag information to the predetermined number of wireless tags of the one or more supplied media. The image forming device forms images on a predetermined number of printing regions corresponding to the predetermined number of wireless tags of the one or more supplied media on the basis of the printing job. The input/output device outputs information for checking whether or not retry processing, which is executed in accordance with a failure to write the tag information, is necessary and receives a request for the retry processing. The processor is configured to detect whether or not writing of the tag information has failed. The processor is further configured to instruct, where the failure to write the tag information has been detected, the input/output device to output the information for checking whether or not retry processing is necessary. The processor is further configured to control, where the input/output device has received the request for the retry processing, execution of the retry processing.

An image forming apparatus according to an embodiment will be described below with reference to the drawings. In the drawings, the same reference symbols denote the same or similar portions.

### [Configuration]

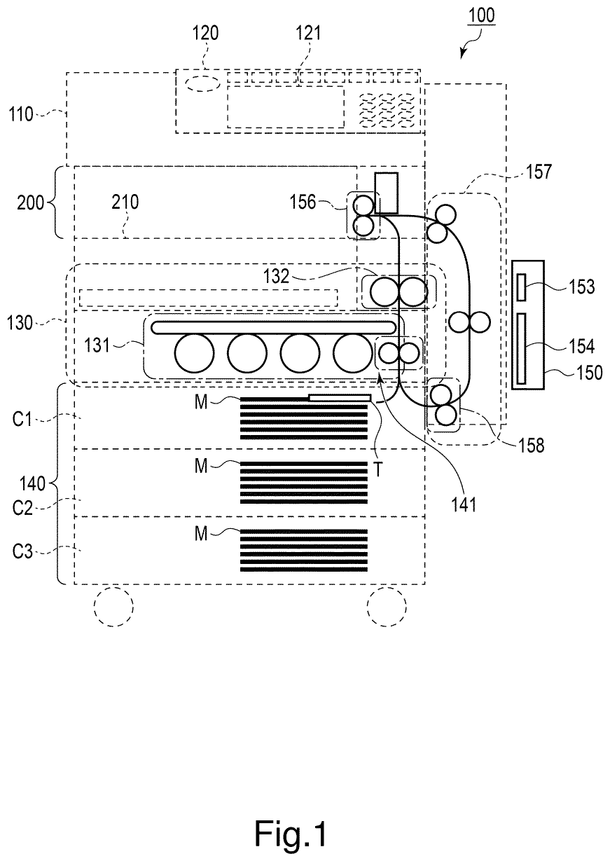

FIG. 1 is a schematic diagram showing an example of the image forming apparatus according to the embodiment.

An image forming apparatus 100 is, for example, a multifunction device. The image forming apparatus 100 includes an image reading device 110, a control panel 120, a display 121, an image forming device 130, a media housing device 140, an RFID processing device 150, and a media receiving unit 200.

For example, the image forming apparatus 100 forms an image on a sheet-shaped medium M using a developer such as a toner. The medium M is paper or label paper. The medium M only needs to have a surface on which an image can be form.

For example, a predetermined number, which is two or more, of wireless tags T are attached to one surface of the medium M. The wireless tag T is a tag using an RFID technology and is referred to also as an RFID tag. The wireless tag T contains identification information and the like.

The display 121 is an image display device such as a liquid crystal display and an organic electro luminescence (EL) display. The display 121 displays various types of information relating to the image forming apparatus 100. The display 121 is an example of an input/output device.

The control panel 120 includes a plurality of buttons. The control panel 120 receives a user's operation. The control panel 120 outputs a signal according to the operation performed by the user to the processor of the image forming apparatus 100. The control panel 120 is an example of an input/output device.

Note that the control panel 120 and the display 121 may be configured as an integrated touch panel.

The image forming device 130 is an image forming device that forms an image on the supplied medium M on the basis of the image information generated by the image reading device 110 or image information received via an external interface 164. For example, the image forming device 130 forms images on a predetermined number of printing regions corresponding to the predetermined number, which is two or more, of wireless tags T, of the supplied medium M. The image forming device 130 forms an image by, for example, the following processing. The image forming device 130 forms an electrostatic latent image on a photoreceptor drum on the basis of image information. The image forming device 130 forms attaches a developer to the electrostatic latent image to form a visible image. Specific examples of the developer include a toner. The image forming device 130 transfers the visible image to the medium M. The image forming device 130 applies heat and pressure to the medium M to fix the visible image onto the medium M.

Note that the medium M on which an image is formed may be the medium M housed in the media housing device 140 or the manually fed medium M. The medium M on which an image has been formed is output to the media receiving unit 200.

The media housing device 140 houses the medium M to be used for forming an image in the image forming device 130. The media housing device 140 includes one or a plurality of cassettes. In this embodiment, the media housing device 140 includes cassettes C1, C2, and C3. For example, each of the cassettes C1, C2, and C3 houses the medium M to which the predetermined number, which is two or more, of wireless tags T, are attached.

The image reading device 110 is an image acquisition unit that acquires an image. The image reading device 110 reads image information to be read, as brightness and darkness of light. The image reading device 110 records the read image information. The recorded image information may be transmitted to another information processing apparatus via a network. Further, the recorded image information may be formed as an image on the medium M by the image forming device 130.

Next, the inside of the image forming apparatus 100 will be described in detail.

The image forming apparatus 100 includes a supply device 141, an output device 156, and a reversal path 157. The reversal path 157 includes a resist device 158.

The image forming device 130 includes an image transfer device 131 and a fixing device 132. The image transfer device 131 includes one or more types of toner. For example, the image transfer device 131 includes yellow, cyan, magenta, and black toners from the upstream side (left side of FIG. 1). Further, the predetermined toner may be a special toner such as a color fadable toner. The image transfer device 131 includes a developing device, a photoreceptor drum, and a charging device for each toner.

The charging device uniformly charges the surface (photoreceptor layer) of the photoreceptor drum. The photoreceptor drum is irradiated with a laser beam to carry an electrostatic latent image on the surface thereof. The developing device adds the toner to the electrostatic latent image to develop a visible image from the electrostatic latent image.

Further, the image transfer device 131 includes a transfer belt. The images developed by the respective toners are successively transferred to the transfer belt in a superimposed manner. The images transferred in a superimposed manner are then transferred to the medium M by a transfer roller.

Note that although the image forming device 130 forms an image using an intermediate transfer method in this embodiment as described above, for example, a direct transfer method or another transfer method may be used.

The fixing device 132 includes a heating roller and a pressure roller. The heating roller applies heat to the medium M from one surface side of the medium M. The pressure roller applies pressure to the medium M from the other surface side of the medium M. The fixing device 132 applies heat and pressure to the medium M to fix the toner transferred to the medium M.

The supply device 141 supplies the medium M from the cassette of the media housing device 140. The supply device 141 includes a plurality of supply rollers and conveys the medium M using the plurality of supply rollers. Further, the medium M supplied by the supply device 141 passes through a first communication region. For example, the supply device 141 temporarily stops or decelerates a predetermined supply roller to temporarily stop or decelerate the medium M when passing through the first communication region. For example, the predetermined supply roller is a resist roller.

The output device 156 outputs the medium M conveyed inside the image forming apparatus 100. The output device 156 includes an output roller.

The reversal path 157 is a path for reversing the front and back of the medium M and is used when forming images on both surfaces of the medium M. The reversal path 157 is a path that reverses the medium M conveyed to the output device 156 by a switchback and conveys the reversed medium M.

The resist device 158 is provided in the reversal path 157. In this embodiment, the resist device 158 will be described as a resist roller provided at the most downstream of the reversal path 157. The resist device 158 temporarily stops the conveyance of the medium M. The resist device 158 stops the conveyance of the medium M to correct the tilt of the medium M to be perpendicular to the conveying direction. Note that the position of the resist device 158 is not limited to the most downstream of the reversal path 157. The resist device 158 may be provided at any position as long as it is a resist roller provided in the path between the output device 156 and the reversal path 157.

The RFID processing device 150 is a wireless communication device that wirelessly communicates with the wireless tag T of the medium M passing through the first communication region located between the supply device 141 and the media receiving unit 200. For example, the RFID processing device 150 is provided outside the reversal path 157. The RFID processing device 150 includes a controller referred to as an RFID module 153, an antenna substrate 154, and an interface unit. For example, an antenna formed in the antenna substrate 154 receives, through wireless communication, information from the wireless tag T of the medium M that is fed from the media housing device 140 or a bypass tray and passes through the first communication region, and transmits information to be written to the wireless tag T. For example, the antenna wirelessly communicates with the wireless tag T of the medium M passing through the supply roller of the supply device 141. Note that the center of the first communication region is located at a first distance from the center of the antenna formed in the antenna substrate 154 and the antenna transmits a radio wave of a first output to communicate with the wireless tag T in the first communication region described above.

The media receiving unit 200 receives the medium M output from the output device 156. The media receiving unit 200 includes a tray 210. Further, the media receiving unit 200 has a second communication region located at a second distance from the antenna formed in the antenna substrate 154. For example, the second distance is a distance from the center of the second communication region to the center of the antenna. The second distance is longer than the first distance. The antenna outputs a radio wave of a second output higher than the first output to communicate with the wireless tag T in the second communication region described above.

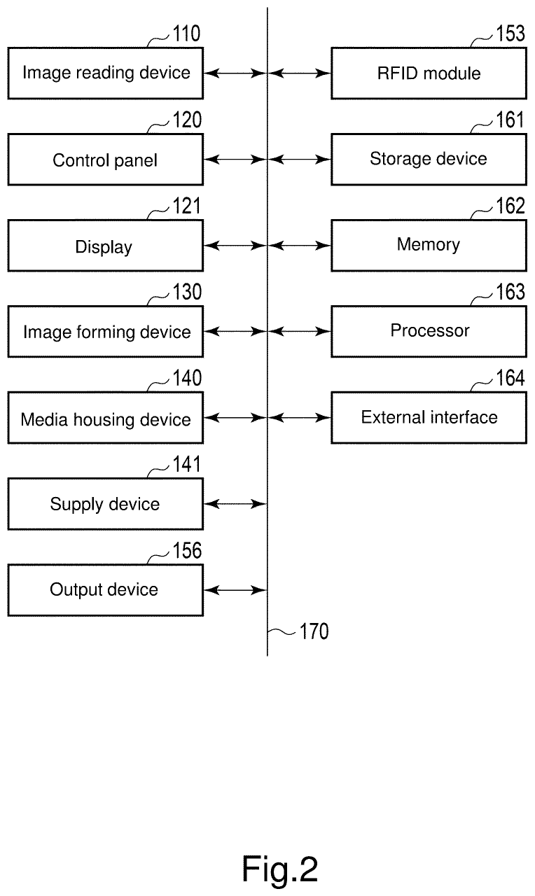

FIG. 2 is a block diagram showing an example of a hardware configuration of the image forming apparatus according to the embodiment.

The image forming apparatus 100 includes the image reading device 110, the control panel 120, the display 121, the image forming device 130, the media housing device 140, the supply device 141, the output device 156, the RFID module 153, a storage device 161, a memory 162, a processor 163, and the external interface 164.

The media housing device 140 houses the medium M to which the wireless tag T is attached.

The supply device 141 is a mechanism that feeds the medium M housed in the media housing device 140 to the image forming device 130. The RFID module 153, the storage device 161, the memory 162, the processor 163, and the external interface 164 will be described below. Note that the respective units are connected to each other so as to be capable of performing data communication via a systema bus 170.

The storage device 161 is, for example, a hard disk or a solid state drive (SSD) and stores various types of data. The various types of data are a printing job received from an external communication device and a software program for controlling the operations of the respective units of the image forming apparatus 100. The printing job contains image information to be printed on the medium M. Further, the storage device 161 stores retry data. The retry data includes tag information that failed to be written and image information that was not printed due to the failure to write the tag information.

The memory 162 temporarily stores data to be used by the respective units of the image forming apparatus 100. The memory 162 includes a volatile memory and a non-volatile memory. The memory 162 may store digital data generated by the image reading device 110. Further, the memory 162 may temporarily store a printing job that printing is being performed by the image forming device 130 and writing information to be written to a wireless tag.

The processor 163 is a control unit that controls the operations of the respective units of the image forming apparatus 100. The processor 163 loads the software program stored in the storage device 161 onto the memory 162 and executes the software program, thereby executing processing. Now, an example of the processing executed by the processor 163 will be described.

The processor 163 controls, on the basis of the printing job received via an external communication device, printing on the medium M to which a wireless tag is attached. The processor 163 acquires, upon receiving a printing job relating to the medium M to which a wireless tag is attached, writing information designated in the printing job and image information associated with the writing information from a writing information server or the like. The image information associated with the writing information is information relating to an image to be formed on the medium M. Note that the image information does not necessarily need to be associated with writing information. In this case, the image information only needs to be included in a printing job.

The processor 163 controls the supply device 141 to supply the medium M. The supply device 141 supplies the medium M to the respective units on the basis of the control of the processor 163. Further, the processor 163 controls the output device 156 to output the medium M. The output device 156 outputs the medium M to the media receiving unit 200 on the basis of the control of the processor 163.

The processor 163 controls the image forming device 130. The image forming device 130 forms the image indicated by the image information on the medium M. The medium M on which the image has been formed is output to the media receiving unit 200.

The processor 163 controls the RFID module 153. The RFID module 153 includes an arithmetic logic unit and a storage device. The RFID module 153 writes information to the wireless tag attached to the medium M. Further, the RFID module 153 reads the information from the wireless tag attached to the medium M. The information read by the RFID module 153 from the wireless tag includes, for example, identification information (e.g., a unique identifier (UID)) for uniquely identifying the wireless tag.

The external interface 164 transmits/receives data to/from an external device. The external device is, for example, an information processing apparatus such as a personal computer, a tablet computer, and a smart device. The external interface 164 operates as an input interface and receives data or an instruction transmitted from the external device. The instruction transmitted from the external device is a printing job or the like. The data transmitted from the external device is writing information and image information associated with the writing information, for example. Further, the external interface 164 functions as an output interface and transmits data to the external device. Note that the external device stores application software that transmits writing information and image information associated with the writing information and transmits a printing job including writing information and image information.

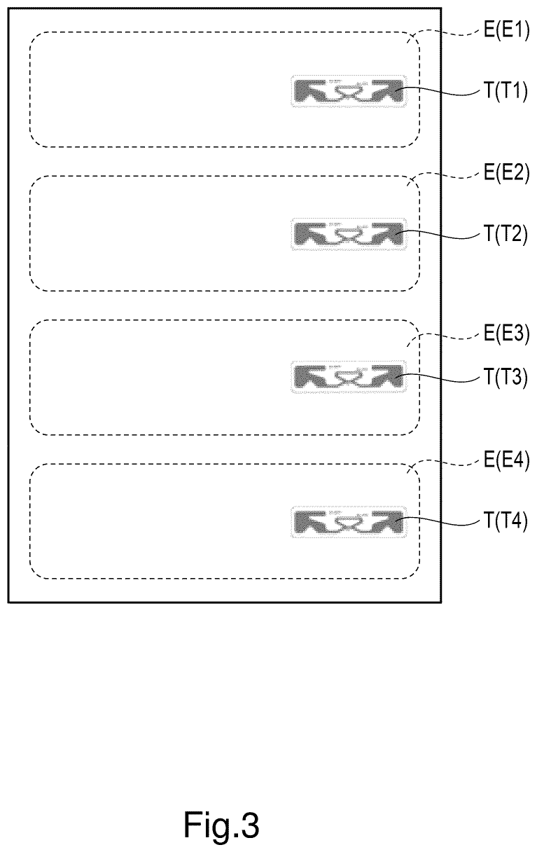

FIG. 3 is a diagram showing an example of a predetermined number of wireless tags on the medium according to the embodiment and a predetermined number of printing regions.

The medium M includes the predetermined number, which is two or more, of wireless tags T, on one surface thereof, and has a predetermined number, which is two or more, of printing regions E corresponding to the predetermined number, which is two or more, of wireless tags T, on the other surface. That is, the medium M includes the predetermined number of wireless tags T on one surface and has the predetermined number of printing regions E on the other surface, the surfaces corresponding to the front and back.

For example, as shown in FIG. 3, the medium M includes four wireless tags T1, T2, T3, and T4 on one surface and has four printing regions E1, E2, E3, and E4 on the other surface.

The processor 163 instructs to write tag information to the predetermined number of wireless tags T and instructs to form images on the predetermined number of printing regions E on the basis of the printing job. The RFID module 153 writes tag information to the predetermined number of wireless tags T on the basis of the instruction from the processor 163. The image forming device 130 forms images on the predetermined number of printing regions E on the basis of the instruction from the processor 163. The tag information to be written to the predetermined wireless tag T and the image to be formed on the predetermined printing region E are, for example, pieces of product information in a corresponding relationship. For example, the tag information to be written to the predetermined wireless tag T is code data of a product, and the image to be formed on the predetermined printing region E is a barcode of the product. The predetermined number of printing regions E are cut out from one medium M and each of the cut-out regions E is used as a product label.

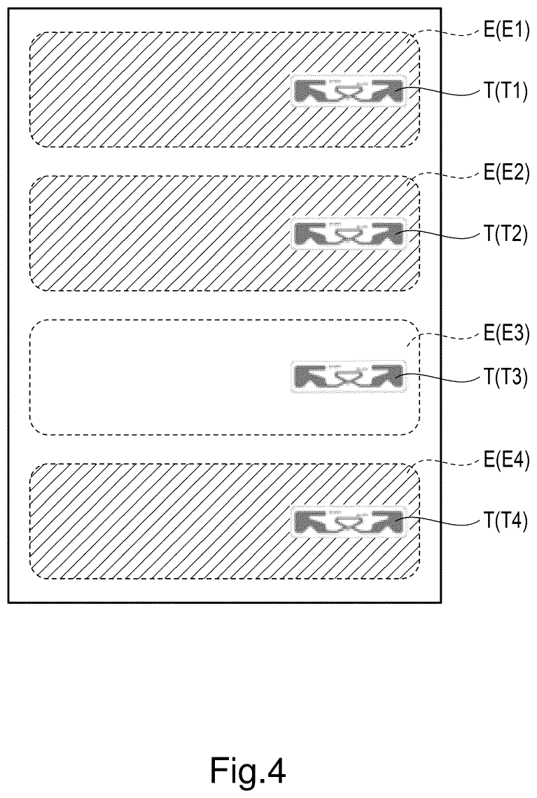

FIG. 4 is a diagram showing an example of writing information to the predetermined number of wireless tags on the medium according to the embodiment and printing images on the printing regions according to the writing results.

In the case where the RFID module 153 has succeeded in writing tag information to the wireless tags T1, T2, and T4, the image forming device 130 forms images corresponding to the tag information on the printing regions E1, E2, and E4.

In the case where the RFID module 153 has failed to write tag information to the wireless tag T3, the image forming device 130 does not form an image on the printing region E3 or forms a warning image corresponding to the failure of writing.

### [Operation]

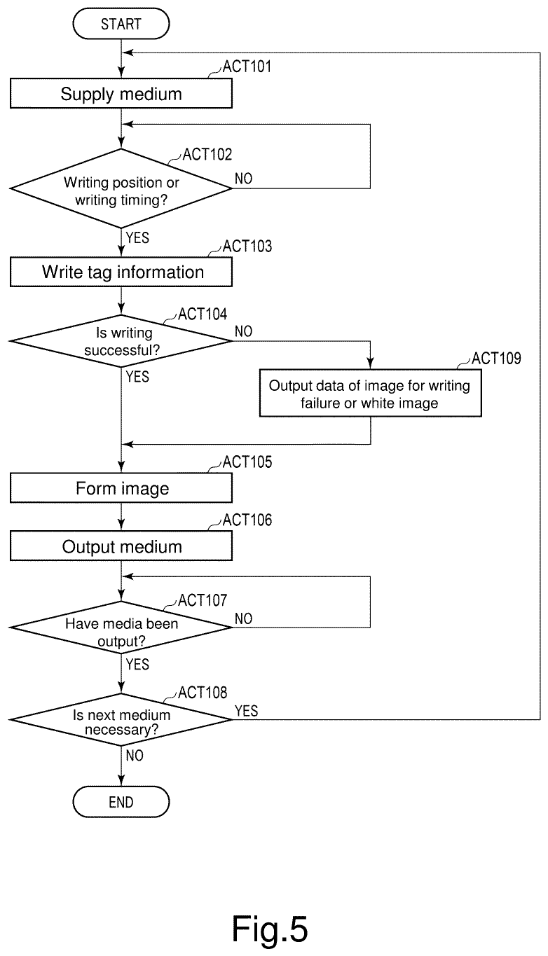

FIG. 5 is a flowchart showing an example of media processing according to the embodiment. The external interface 164 inputs one or more printing jobs output from an external device such as a personal computer, and the processor 163 executes media processing on the basis of the one or more input printing jobs. For example, the processor 163 executes media processing on the basis of the input first and second printing jobs.

First, the processor 163 executes media processing based on the first printing job. The processor 163 controls the supply device 141 on the basis of the first printing job to supply one or more media M requested in the first printing job. The supply device 141 starts supplying the one or more media M (ACT101). Further, the processor 163 controls the image forming device 130 on the basis of the first printing job to start preparing for printing on the plurality of printing regions E of the top medium M.

Subsequently, the processor 163 controls the RFID module 153 on the basis of the first printing job. The RFID module 153 transmits a radio wave of a predetermined output to wirelessly communicate with the plurality of wireless tags T of the medium M passing through the communication region located between the supply device 141 and the media receiving unit 200. The RFID module 153 writes tag information to the plurality of wireless tags T (ACT103) at the writing position or writing timing detected by the processor 163 (ACT102, YES).

Further, the RFID module 153 reads the tag information written to the wireless tag T and outputs the reading result. In the case where the writing is successful, the reading result includes wireless tag identification information unique to each wireless tag T and the written tag information.

In the case where the reading result includes the wireless tag identification information unique to each wireless tag T and correct tag information, the processor 163 determines that the writing of tag information is successful (ACT104, YES).

The processor 163 causes the image forming device 130 to form an image on the printing region E corresponding to the wireless tag T that has been successfully written. For example, in the case where writing of tag information to the wireless tags T1, T2, and T4 has been successful, the image forming device 130 prints images on the printing regions E1, E2, and E4 (ACT105).

In the case where the reading result includes wireless tag identification information but does not include correct tag information, the processor 163 determines that the writing of tag information has failed (ACT104, NO). Further, in the case where the reading result does not include wireless tag identification information, the processor 163 also determines that the writing of tag information has failed (ACT104, NO).

The processor 163 outputs data for forming an image for a writing failure on the printing region E corresponding to the wireless tag T that has failed to be written (ACT109). Alternatively, the processor 163 masks the output of image data for forming a white image on the printing region E corresponding to the wireless tag T that has failed to be written (ACT109). The image forming device 130 prints the image for a writing failure or the white image on the printing region E3 (ACT105). The image forming device 130 replaces, in accordance with detection of a failure to write tag information to the wireless tag T3, the image for a writing success on the printing region E3 with the image for a writing failure to form the image for a writing failure on the printing region E3. For example, the image for a writing failure includes information indicating that the writing has failed. Further, the image forming device 130 masks, in accordance with detection of a failure to write tag information to the wireless tag T3, the exposure processing of the image for a writing success on the printing region E3 to form a white image on the printing region E3. Note that forming the white image is synonymous with forming no image.

The storage device 161 stores the tag information that has not been written due to a failure and the image information that has not been printed due to a failure. For example, the storage device 161 stores the tag information that has not been written to the wireless tag T3 and the image information that has not been printed on the printing region E3.

The supply device 141 conveys the medium M subjected to the image formation processing, and the output device 156 outputs the medium M to the media receiving unit 200 (ACT106). The processor 163 causes, in the case where the medium M has been output (ACT107, YES) and it is determined that it is necessary to supply the next medium M based on the first printing job (ACT108, YES), the supply device 141 to supply the next medium M.

The processor 163 executes media processing based on a second printing job when the one or more media M requested in the first printing job has been supplied and the formation of an image and the output of the medium M have been completed. Since the media processing based on the second printing job is the same as the media processing based on the first printing job, detailed description thereof is omitted.

When the media processing based on the first and second printing jobs ends, the supply of the next medium M is unnecessary (ACT108, NO), the processor 163 ends the media processing. As described above, the image forming apparatus 100 prints, in accordance with a failure to write tag information to the wireless tag T, an image for a writing failure or a white image on the printing region E corresponding to this wireless tag T. This printing makes it easier to distinguish between the wireless tag T that has been successfully written and the wireless tag T that has failed to be written. Further, in the case of printing a white image, the effect of toner saving can be achieved.

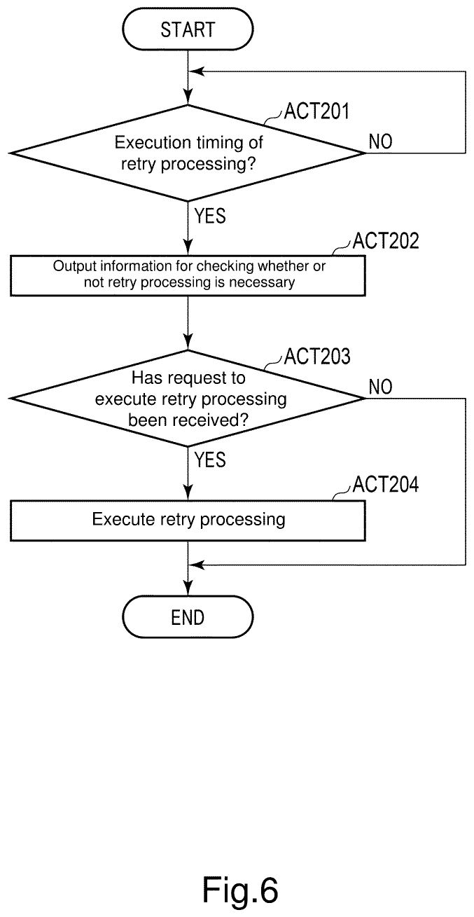

FIG. 6 is a diagram showing an example of retry processing according to the embodiment. The processor 163 determines execution timing of retry processing on the basis of first determination criteria for determining the execution timing of the retry processing (ACT201). For example, the processor 163 executes the media processing based on the first printing job and determines, in accordance with detection of a failure to write tag information to one or more wireless tags, that it is the execution timing of retry processing after the first printing job ends (ACT201, YES).

The processor 163 instructs to output information for checking whether or not the retry processing is necessary, and the display 121 outputs information for checking whether or not the retry processing is necessary (ACT202). When the control panel 120 or the display 121 receives a request to execute retry processing (ACT203, YES), the processor 163 executes retry processing (ACT204).

When the control panel 120 or the display 121 receives a request to execute no retry processing (ACT203, NO), the processor 163 skips the retry processing and instructs to output information for checking whether or not the retry processing is necessary again at the execution timing of the next retry processing.

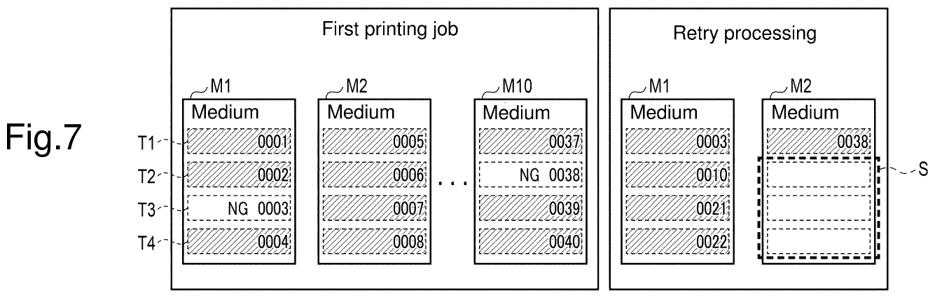

FIG. 7 is a diagram describing an example of the printing job and the retry processing according to the embodiment. For example, assumption is made that one medium M includes four wireless tags T and the first printing job is a job for 40 wireless tags T included in 10 media M (prerequisite 1). The image forming apparatus 100 sequentially supplies 10 media M in accordance with the execution of the first printing job. The image forming apparatus 100 sequentially writes pieces of tag information 0001 to 0040 to the 40 wireless tags T of the 10 media M and forms images on 40 printing regions of the 10 media M.

In the case where writing of tag information to the predetermined wireless tag T has failed, the image forming apparatus 100 stores, in the storage device 161, retry data that includes the tag information that has failed to be written and the image information that has not been printed due to a failure to write tag information. For example, assumption is made that writing of pieces of tag information 0003, 0010, 0021, 0022, and 0038 has failed (prerequisite 2).

The image forming apparatus 100 executes retry processing on the basis of the first determination criteria for determining the execution timing of the retry processing. For example, in the case where writing of tag information has failed in the first printing job, the image forming apparatus 100 executes retry processing after the execution of media processing based on the first printing job. The retry processing is processing of supplying the necessary number, which is one or more, of media M, writing the tag information that has failed to be written in the first printing job to the predetermined number of wireless tags T of the necessary number, which is one or more, of supplied media M, and forming an image on the printing region E corresponding to the wireless tag T to which the tag information has been written. That is, the image forming apparatus 100 sequentially writes pieces of tag information 0003, 0010, 0021, 0022, and 0038 to five wireless tags T of two media M on the basis of the retry data, and forms images on the five printing region corresponding to the five wireless tags T of the two media M.

Note that in the case where the number of wireless tags T to which tag information has failed to be written is not an integer multiple of the number of wireless tags T included in the medium M, the retry processing will result in one or more excess wireless tags S on one medium M. At time point, the excess wireless tag S is not used as a product tag or the like.

In this regard, the image forming apparatus 100 instructs, before executing the retry processing, the output of information for checking whether or not the retry processing, which is executed in accordance with a failure to write tag information, is necessary. The image forming apparatus 100 executes retry processing in the case where a request for retry processing has been received and postpones the retry processing in the case where the request for retry processing has not been received. This allows the generation of the excess wireless tag S to be suppressed.

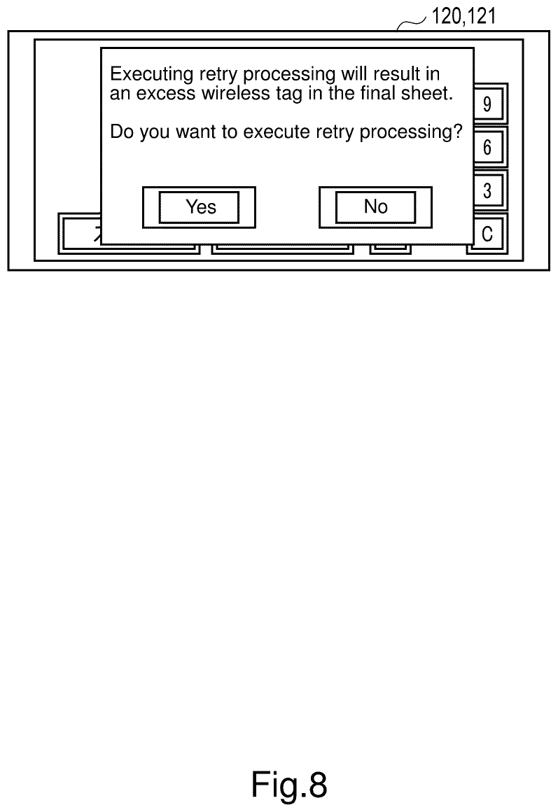

FIG. 8 is a diagram showing an example of outputting information for checking whether or not the retry processing is necessary according to the embodiment. As shown in FIG. 8, the control panel 120 and the display 121 display information for checking whether or not the retry processing is necessary. The necessity checking information includes information indicating that the retry processing will result in one or more excess wireless tags in one medium in the case where the number of wireless tags T that have failed to be written in the printing job is not an integer multiple of the predetermined number. For example, the necessity checking information includes the guidance of “Executing retry processing will result in an excess wireless tag in the final sheet” and “Do you want to execute retry processing”. The control panel 120 and the display 121 receives a request to execute retry processing via the option “Yes” and receives a request to execute no retry processing via the option “No”.

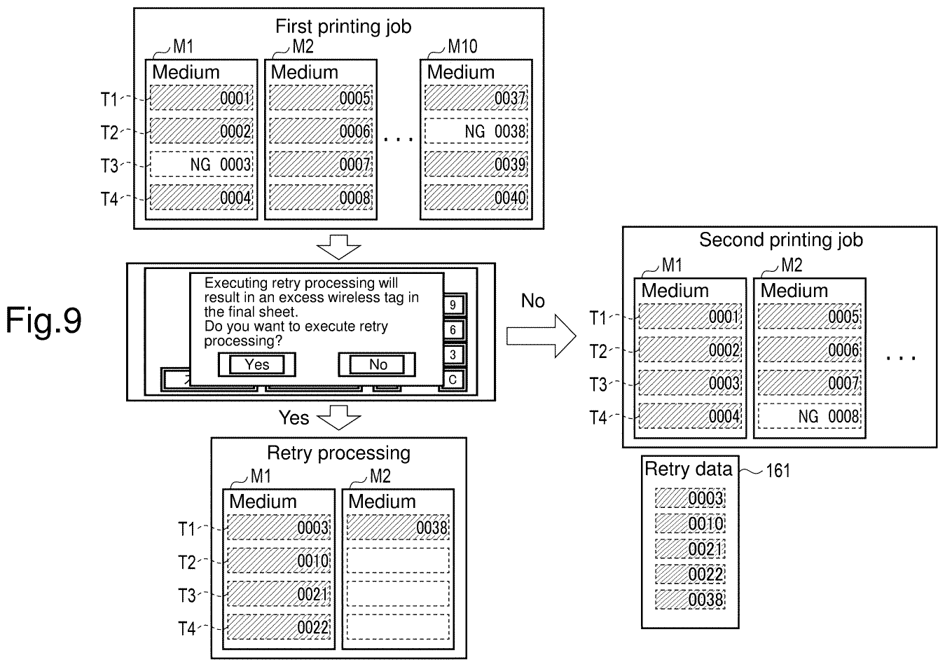

FIG. 9 is a schematic diagram showing an example of state transition according to the necessity of executing retry processing according to the embodiment. A case where the image forming apparatus 100 inputs the first and second printing jobs, executes the first printing job, and then executes the second printing job will be described. Assumption is made that one medium M includes four wireless tags T and the first and second printing jobs are jobs for 40 wireless tags T included in 10 media M.

The processor 163 executes the first printing job. In the case where a failure to write tag information has occurred in the first printing job, the storage device 161 stores retry data including the tag information that has filed to be written and the image information that has not been printed due to a failure to write tag information. The processor 163 instructs, after executing the first printing job and before executing the second printing job, the output of information for checking whether or not the retry processing is necessary. The control panel 120 and the display 121 display information for checking whether or not the retry processing is necessary. For example, assumption is made that writing of pieces of tag information 0003, 0010, 0021, 0022, and 0038 has failed.

When the control panel 120 and the display 121 receive a request to execute retry processing via the option “Yes”, the processor 163 executes retry processing. The supply device 141 sequentially supplies the necessary number of (two) media M, the RFID module 153 sequentially writes pieces of tag information 0003, 0010, 0021, 0022, and 0038 to five wireless tags T of the two media M on the basis of the retry data, and the image forming device 130 forms images on the five printing regions corresponding to the five wireless tags T of the two media M.

Note that the processor 163 may execute retry processing in units of the number of wireless tags T included in the medium M. That is, the processor 163 may execute retry processing in units of the predetermined number. In the case where writing has failed for five wireless tags T, the processor 163 executes retry processing to sequentially write pieces of tag information 0003, 0010, 0021, and 0022 to four wireless tags included in one medium M. The processor 163 temporarily suspends the writing of the remaining tag information 0038.

In the case where writing to three wireless tags T has filed newly, the processor 163 executes retry processing to sequentially write the pieces of tag information that have failed to be written (including the tag information 0038) to four wireless tags T included in one medium M. This allows the wireless tag T on the medium M to be used without waste.

When the control panel 120 and the display 121 receives a request to execute no retry processing via the option “No”, the storage device 161 keeps the retry data and the processor 163 executes the second printing job.

In the case where writing tag information has not failed in the second printing job and the second printing job has ended, the processor 163 instructs to output information for checking whether or not the retry processing is necessary. The control panel 120 and the display 121 display the information for checking whether or not the retry processing is necessary. When the control panel 120 and the display 121 receive a request to execute retry processing via the option “Yes”, the processor 163 executes retry processing. The retry processing to be executed in this case includes writing tag information and forming an image, which have not executed due to a failure to write tag information in the first printing job.

Further, in the case where writing of tag information has failed in the second printing job, the storage device 161 stores retry data including the tag information that has failed to be written and the image information that has not been printed due to a failure to write tag information. The processor 163 instructs to output information for checking whether or not the retry processing is necessary, after executing the second printing job. The control panel 120 and the display 121 display the information for checking whether or not the retry processing is necessary.

When the control panel 120 and the display 121 receive a request to execute retry processing via the option “Yes”, the processor 163 executes retry processing. The retry processing to be executed in this case includes writing tag information and forming an image, which have not executed due to a failure to write tag information in the first and second printing jobs. That is, the image forming apparatus 100 collectively executes writing tag information and forming an image, which have not executed due to a failure to write tag information in a plurality of printing jobs. This allows the generation of the excess wireless tag S to be suppressed.

Note that the processor 163 may select whether or not to output the necessity checking information in accordance with the presence or absence of the excess wireless tag S. That is, the processor 163 executes retry processing without outputting the necessity checking information in the case where no excess wireless tag S is generated. In the case where the excess wireless tag S is generated, the processor 163 outputs necessity checking information and executes retry processing upon receiving a request to execute retry processing. This reduces the effort to check the necessity of retry processing and also allows the wireless tag T of the medium M to be used efficiently.

Subsequently, a modification of the determination criteria for determining execution timing of retry processing will be described. The case where after executing media processing based on the first printing job, retry processing including writing tag information and forming an image, which have not executed due to a failure to write tag information in this first printing job, is executed as shown in FIG. 7 has been described above. The execution timing of retry processing is not limited thereto, and the retry processing may be executed at the following timing.

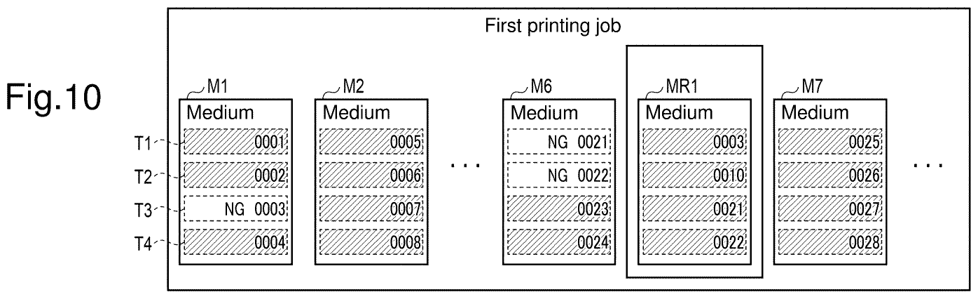

FIG. 10 is a diagram showing a first modification of the determination criteria for determining execution timing of retry processing according to the embodiment. The processor 163 executes the first printing job for a plurality of media. On the basis of second determination criteria for determining execution timing of retry processing, the processor 163 determines, in the case where a failure to write tag information to the predetermined number of wireless tags T has been detected at the time point when writing of tag information and formation of an image on the Nth (N is a natural number) medium M were completed, that it is the execution timing of retry processing. The predetermined number is the number of wireless tags T included in the medium M.

The first modification will be described by applying the prerequisites 1 and 2 described with reference to FIG. 7. In this case, the predetermined number is four. The processor 163 executes media processing based on the first printing job, and executes retry processing in the case where the number of wireless tags T that have failed to be written reaches four at the time point when writing of tag information and formation of an image on the predetermined medium M were completed. That is, the processor 163 executes retry processing in accordance with detection of a failure to write pieces of tag information 0003, 0010, 0021, and 0022.

The supply device 141 supplies one medium M, the RFID module 153 sequentially writes pieces of tag information 0003, 0010, 0021, and 0022 to four wireless tags T of one medium M on the basis of the retry data stored in the storage device 161, and the image forming device 130 forms images on the four printing regions corresponding to the four wireless tags T of one medium M. After the retry processing ends, the processor 163 executes the remaining processing of the first printing job.

After the retry processing is completed, the retry data may be deleted from the storage device 161. This increases the utilization efficiency of the wireless tag T of the medium M and allows the storage region of retry data provided in the storage device 161 to be reduced.

Note that also in the first modification described here, the processor 163 may instruct to output information for checking whether or not the retry processing is necessary upon determining that it is the execution timing of retry processing, and execute retry processing on the basis of reception of a request to execute retry processing. This allows retry processing to be executed after confirming the user's will.

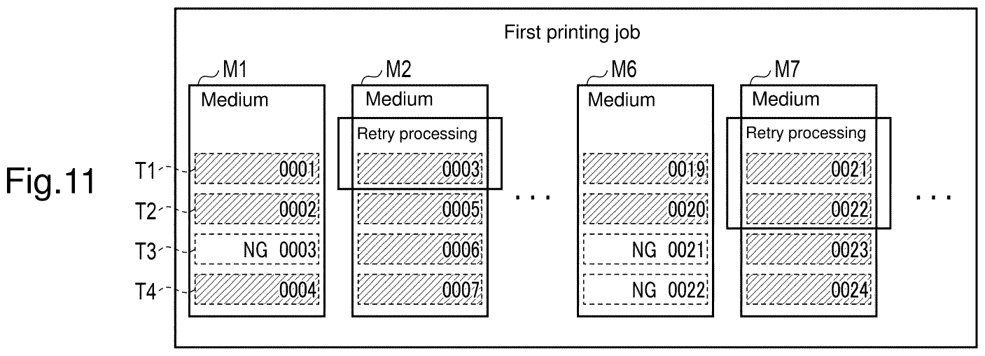

FIG. 11 is a diagram showing a second modification of determination criteria for determining execution timing of retry processing according to the embodiment. The processor 163 executes the first printing job. On the basis of third determination criteria for determining execution timing of retry processing, the processor 163 determines, in the case where a failure to write tag information to one or more wireless tags T has been detected at the time point when writing of tag information and formation of an image on the Nth (N is a natural number) medium M were completed, that it is the execution timing of retry processing.

The second modification will be described by applying the prerequisites 1 and 2 described with reference to FIG. 7. The processor 163 executes media processing based on the first printing job, executes retry processing in the case where a failure to write tag information 0003 has been detected at the time point when writing of tag information and formation of an image on the first medium M were completed, and continuously executes the remaining media processing based on the first printing job.

The supply device 141 supplies one medium M, the RFID module 153 sequentially writes pieces of tag information 0003, 0005, 0006, and 0007 to four wireless tags T of one medium M on the basis of the retry data stored in the storage device 161, and the image forming device 130 forms images on the four printing regions corresponding to the four wireless tags T of one medium M.

Further, the processor 163 executes retry processing in the case where a failure to write pieces of tag information 0021 and 0022 has been detected at the time point when writing of tag information and formation of an image on the sixth medium M were completed, and continuously executed the remaining media processing based on the first printing job.

The supply device 141 supplies one medium M, the RFID module 153 sequentially writes pieces of tag information 0021, 0022, 0023, and 0024 to four wireless tags T of one medium M on the basis of the retry data stored in the storage device 161, and the image forming device 130 forms images on the four printing regions corresponding to the four wireless tags T of one medium M.

After the retry processing is completed, the retry data may be deleted from the storage device 161. This allows the storage region of retry data provided in the storage device 161 to be reduced without reducing the utilization efficiency of the wireless tag T of the medium M.

For example, in the case where writing of first tag information to a first wireless tag T of a first medium M has failed, the first tag information that has failed to be written is written to a second wireless tag of a second medium M supplied immediately after the first medium M. This allows the second wireless tag T that is used instead of the first wireless tag T to be obtained from the second medium M supplied immediately after. This makes it possible to improve the convenience when using wireless tags in sequential numbers.

Note that also in the second modification described here, the processor 163 may instruct to output information for checking whether or not the retry processing is necessary upon determining that it is the execution timing of retry processing, and execute retry processing on the basis of reception of a request to execute retry processing. This allows retry processing to be executed after confirming the user's will.

As described above, according to this embodiment, it is possible to provide an image forming apparatus that allows retry processing according to the user's will to be executed in the case where information cannot be written to a wireless tag of a medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an interface configured to input a printing job;
a supply device configured to supply, on a basis of the printing job, one or more media to which a predetermined number, which is two or more, of wireless tags are attached;
a wireless communication device configured to communicate with the predetermined number of wireless tags of the one or more supplied media on a basis of the printing job and write tag information to the predetermined number of wireless tags of the one or more supplied media;
an image forming device configured to form images on a predetermined number of printing regions corresponding to the predetermined number of wireless tags of the one or more supplied media on a basis of the printing job;
an input/output device configured to output information for checking whether or not retry processing, which is executed in accordance with a failure to write the tag information, is necessary and receive a request for the retry processing; and
a processor configured to
detect whether or not writing of the tag information has failed,
instruct, where the failure to write the tag information has been detected, the input/output device to output the information for checking whether or not retry processing is necessary, and
control, where the input/output device has received the request for the retry processing, execution of the retry processing.

2. The image forming apparatus according to claim 1, wherein
the interface inputs the first and second printing jobs, and
the processor is further configured to instruct, where writing of the tag information has failed in the first printing job, the input/output device to output the information for checking whether or not retry processing is necessary after executing the first printing job and before executing the second printing job.

3. The image forming apparatus according to claim 1, wherein
the information for checking whether or not retry processing is necessary includes, where the number of wireless tags which have failed to be written in the printing job is not an integer multiple of the predetermined number, information indicating that the retry processing will result in one or more excess wireless tags in one medium.

4. The image forming apparatus according to claim 1, wherein
the retry processing includes supplying one or more media, writing the tag information which has failed to be written in the printing job to the predetermined number of wireless tags of the one or more supplied media, and forming images on printing regions corresponding to the wireless tags to which the tag information has been written.

5. The image forming apparatus according to claim 1, wherein
the processor is further configured to instruct, where a failure to write the tag information to a predetermined number of wireless tags has been detected at a time point when writing of the tag information and formation of an image on a predetermined medium were completed in the printing job for a plurality of media, the input/output device to output the information for checking whether or not retry processing is necessary, and execute the retry processing on a basis of reception of the request for the retry processing, and
the retry processing includes supplying one medium, writing the tag information which has failed to be written to a predetermined number of wireless tags of the one supplied medium, and forming images on printing regions corresponding to the wireless tags to which the tag information has been written.

6. The image forming apparatus according to claim 1, wherein
each of the media has one surface to which a wireless tag is attached and the other surface having a printing region corresponding to the wireless tag.

7. The image forming apparatus according to claim 6, wherein
the tag information to be written to the wireless tag and the image to be formed on the printing region are pieces of information in a corresponding relationship.

8. The image forming apparatus according to claim 7, wherein
the media are media for forming a label of a product,
the tag information is code data of the product, and
the image to be formed on the printing region is a barcode of the product.

9. An image forming apparatus, comprising:
an interface configured to input a printing job;
a supply device configured to supply, on a basis of the printing job, one or more media to which a predetermined number, which is two or more, of wireless tags are attached;
a wireless communication device configured to communicate with the predetermined number of wireless tags of the one or more supplied media on a basis of the printing job and write tag information to the predetermined number of wireless tags of the one or more supplied media;
an image forming device configured to form images on a predetermined number of printing regions corresponding to the predetermined number of wireless tags of the one or more supplied media on a basis of the printing job;
an input/output device configured to output information relating to a failure to write the tag information; and
a processor configured to
detect whether or not writing of the tag information has failed, and
control, where the number of wireless tags which have failed to be written is the predetermined number or an integer multiple of the predetermined number, execution of retry processing.

10. The image forming apparatus according to claim 9, wherein
the processor is further configured to cause, where the number of wireless tags which have failed to be written is neither the predetermined number nor an integer multiple of the predetermined number, the input/output device to output, as the information relating to a failure to write the tag information, information for checking whether or not the retry processing is necessary.

11. The image forming apparatus according to claim 9, wherein
the input/output device outputs the information for checking whether or not the retry processing is necessary and receives a request for the retry processing, and
the processor is further configured to control, where the input/output device has received the request for the retry processing, execution of the retry processing.

12. An image forming apparatus, comprising:
an interface configured to input a printing job;
a supply device configured to supply, on a basis of the printing job, one or more media to which a predetermined number, which is two or more, of wireless tags are attached;
a wireless communication device configured to communicate with the predetermined number of wireless tags of the one or more supplied media on a basis of the printing job and write tag information to the predetermined number of wireless tags of the one or more supplied media;
an image forming device configured to form images on a predetermined number of printing regions corresponding to the predetermined number of wireless tags of the one or more supplied media on a basis of the printing job;
an input/output device configured to output information relating to a failure to write the tag information; and
a processor configured to
detect whether or not writing of the tag information has failed, and
control, where the failure to write the tag information has been detected, the image forming device such that the image forming device forms an image for a writing failure on the printing region.

13. The image forming apparatus according to claim 12, wherein
the processor is further configured to control the image forming device such that the image forming device forms a white image as the image for a writing failure.

14. The image forming apparatus according to claim 13, wherein
the forming the white image includes forming no image on the printing region.

15. The image forming apparatus according to claim 12, wherein
the processor is further configured to control, where the failure to write the tag information has been detected, the image forming device such that the image forming device forms a warning image corresponding to the failure to write the tag information on the printing region.
